(19) United States
(12) Patent Application Publication
(10) Pub. No.: US 2022/0137779 A1
(43) Pub. Date: May 5, 2022

(54) ELECTRONIC DEVICE AND FINGERPRINT IMAGE CORRECTION METHOD

(71) Applicant: Egis Technology Inc., Taipei (TW)

(72) Inventors: Kuan-Yi Lin, Taipei (TW); Chen Yang, Taipei (TW); Kuan-Yuan Wang, Taipei (TW)

(73) Assignee: Egis Technology Inc., Taipei (TW)

(21) Appl. No.: 17/391,042

(22) Filed: Aug. 2, 2021

Related U.S. Application Data
(60) Provisional application No. 63/108,883, filed on Nov. 3, 2020.

(30) Foreign Application Priority Data
Jun. 15, 2021 (CN) 202110662717.2

(51) Int. Cl. G06F 3/041; G06F 3/042

(52) U.S. Cl. CPC G06F 3/04182; G06F 2203/04105; G06F 3/0412; G06F 3/0421

(57) ABSTRACT

An electronic device and a fingerprint image correction method are provided. The electronic device includes an optical fingerprint sensor and a processor. The optical fingerprint sensor is used to obtain a fingerprint image. The processor is coupled to the optical fingerprint sensor. The processor judges multiple analog-to-digital converter values of multiple pixels of the fingerprint image according to a numerical mask to generate a comparison image. The processor compares the comparison image with a sample image to obtain a pressure level classification corresponding to the fingerprint image.

### CROSS-REFERENCE TO RELATED APPLICATION

This application claims the priority benefit of U.S. Provisional Application No. 63/108,883, filed on Nov. 3, 2020 and China Application No. 202110662717.2, filed on Jun. 15, 2021. The entirety of each of the above-mentioned patent applications is hereby incorporated by reference herein and made a part of this specification.

### BACKGROUND

### Technical Field

The disclosure relates to a device and an image processing method, and more particularly to an electronic device and a fingerprint image correction method.

### Description of Related Art

For current electronic devices (for example, handphones or tablets) with fingerprint sensing function, if the in-display fingerprint sensing technology is adopted, when the finger of the user presses the screen, the screen is slightly deformed, which forms fingerprint image noise, resulting in poor fingerprint image quality or reduced reliability, and further affecting subsequent related application effects of a fingerprint image. Therefore, none of the existing fingerprint image optimization measures can effectively remove or reduce the corresponding noise in the fingerprint image. In view of this, solutions in several embodiments will be proposed below.

### SUMMARY

The disclosure provides an electronic device and a fingerprint image correction method, which can perform image correction on a fingerprint image to generate an optimized fingerprint image.

The electronic device of the disclosure includes an optical fingerprint sensor and a processor. The optical fingerprint sensor is used to obtain a fingerprint image. The processor is coupled to the optical fingerprint sensor. The processor judges multiple analog-to-digital converter values of multiple pixels of the fingerprint image according to a numerical mask to generate a comparison image. The processor compares the comparison image with a sample image to obtain a pressure level classification corresponding to the fingerprint image.

The image processing method of the disclosure includes the following steps. A fingerprint image is obtained through an optical fingerprint sensor. Numerical retrieval processing is performed on the fingerprint image according to a numerical mask to generate a reference image. Multiple analog-to-digital converter values of multiple pixels of the fingerprint image are judged according to the numerical mask to generate a comparison image. The comparison image is compared with a sample image to obtain a pressure level classification corresponding to the fingerprint image.

Based on the above, in the electronic device and the fingerprint image correction method of the disclosure, a pressure level of a user pressing a finger on the optical fingerprint sensor during a fingerprint sensing process may be judged to use background data corresponding to the pressure level to correct the fingerprint image.

In order for the features and advantages of the disclosure to be more comprehensible, the following specific embodiments are described in detail in conjunction with the accompanying drawings.

### BRIEF DESCRIPTION OF THE DRAWINGS

FIG. 1 is a schematic diagram of an electronic device according to an embodiment of the disclosure.

FIG. 2 is a flowchart of a fingerprint image correction method according to an embodiment of the disclosure.

FIG. 3 is a schematic diagram of a fingerprint image according to an embodiment of the disclosure.

FIG. 4 is a schematic diagram of a comparison image corresponding to heavy pressing of a finger according to an embodiment of the disclosure.

FIG. 5 is a schematic diagram of a comparison image corresponding to light pressing of a finger according to an embodiment of the disclosure.

FIG. 6 is a schematic diagram of a sample image according to an embodiment of the disclosure.

FIG. 7 is a schematic diagram of comparison between a comparison image and a sample image corresponding to heavy pressing according to an embodiment of the disclosure.

FIG. 8 is a schematic diagram of comparison between a comparison image and a sample image corresponding to light pressing according to an embodiment of the disclosure.

FIG. 9 is a schematic diagram of classification of multiple different pressure levels according to an embodiment of the disclosure.

FIG. 10 is a schematic diagram of classification of multiple different pressure levels according to another embodiment of the disclosure.

### DETAILED DESCRIPTION OF DISCLOSED EMBODIMENTS

In order for the content of the disclosure to be more comprehensible, the following embodiments are specifically cited as examples on which the disclosure can be implemented. In addition, wherever possible, elements/components/steps with the same reference numbers in the drawings and the embodiments represent the same or similar parts.

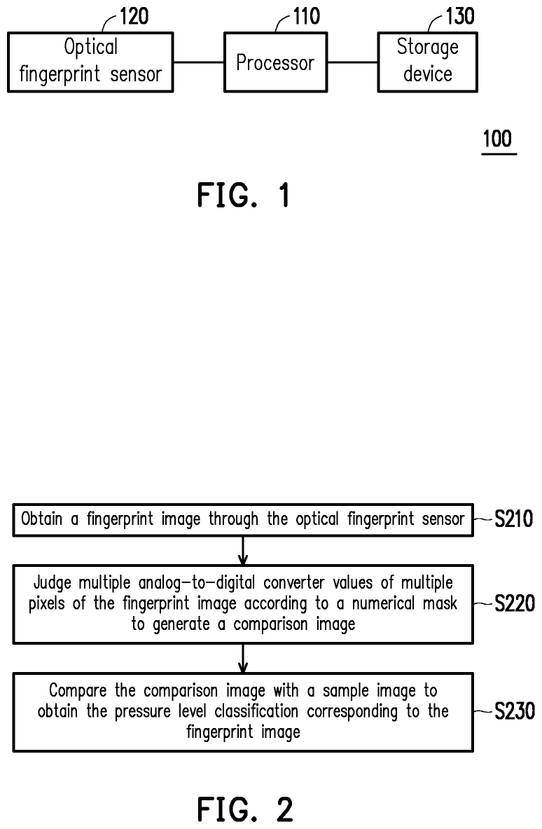

FIG. 1 is a schematic diagram of an electronic device according to an embodiment of the disclosure. Referring to FIG. 1, an electronic device 100 includes a processor 110, an optical fingerprint sensor 120, and a storage device 130. The processor 110 is coupled to the optical fingerprint sensor 120 and the storage device 120. In the embodiment, the electronic device 100 may be an integrated fingerprint sensing module and is disposed in a terminal equipment, such as a handphone. The electronic device 100 may obtain a fingerprint image, correct the fingerprint image to generate an optimized fingerprint image, and then provide the optimized fingerprint image to a computing unit of the terminal equipment for subsequent fingerprint image applications, such as fingerprint registration, fingerprint recognition, or fingerprint verification. In other embodiments, the electronic device 100 may also be directly interpreted as a terminal equipment or a portable electronic equipment such as a smartphone, a tablet computer, or a notebook computer, and the processor 110 and the storage device 130 may be a processing unit and a storage unit of the terminal equipment or the portable electronic equipment.

The processor 110 may be a functional computing circuit in a central processing unit (CPU) or a fingerprint sensing module of a terminal equipment or a portable electronic equipment. Alternatively, the processor 110 may include a hardware circuit designed through hardware description language (HDL) or any other digital circuit design manner well known to persons skilled in the art, and implemented through a field programmable logic gate array (FPGA), a complex programmable logic device (CPLD), or application-specific integrated circuit (ASIC), so that the processor 110 has data computing ability and image processing ability. The processor 110 may also include a related functional circuit constructed by applying an analog circuit.

The storage device 130 may be a memory and may include related data computing algorithms and image processing programs for the processor 110 to execute, so that the processor 110 may access related data. It is worth noting that one of the processor 110 and the optical fingerprint sensor 120 of the embodiment may include an analog-to-digital converter (ADC). The analog-to-digital converter is used to convert an analog sensing signal provided by the optical fingerprint sensor 120 into digital image sensing data. Specifically, the digital image sensing data (that is, the fingerprint image described below) may, for example, include multiple analog-to-digital converter values (ADC codes) corresponding to multiple pixels in an image.

In the embodiment, the electronic device 100 may also include a panel, such as a display panel of a handphone, and the optical fingerprint sensor 120 may be an in-display fingerprint sensor disposed under the panel, such as a lenticular in-display fingerprint sensor. When a user places or presses a finger on the panel corresponding to the position of the optical fingerprint sensor 120, so that the optical fingerprint sensor 120 performs fingerprint sensing, the result of the finger of the user applying pressure on the panel is that the panel may be deformed, which causes the fingerprint image provided by the optical fingerprint sensor 120 to have noise. The noise changes with different pressing force of the finger of the user. Generally speaking, the greater the pressing force, the greater the range of noise in the fingerprint image, but the disclosure is not limited thereto. Therefore, in order to effectively remove or reduce the noise in the fingerprint image, the processor 110 of the embodiment may perform image analysis on the fingerprint image to effectively judge a pressure level classification corresponding to the fingerprint image, thereby using background data (for example, a background image) corresponding to the pressure level classification to perform effective noise removal processing (background noise removal processing) on the fingerprint image.

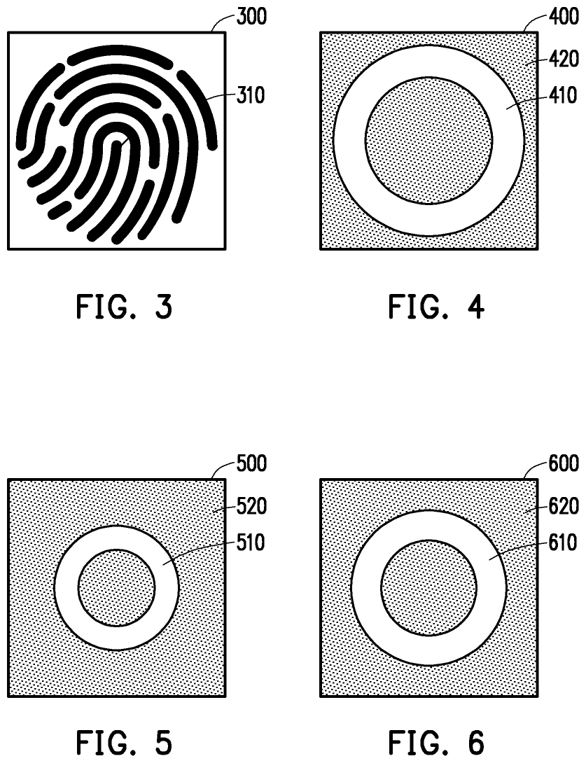

FIG. 2 is a flowchart of a fingerprint image correction method according to an embodiment of the disclosure. Referring to FIG. 1 and FIG. 2, the electronic device 100 of the embodiment may execute Steps S210 to S230 as below. With reference to FIG. 3, in Step S210, the electronic device 100 obtains a fingerprint image 300 through the optical fingerprint sensor 120. The optical fingerprint sensor 120 may obtain the fingerprint image 300 having a fingerprint pattern image 310 as shown in FIG. 3. FIG. 4 is a schematic diagram of a comparison image corresponding to heavy pressing of a finger according to an embodiment of the disclosure. FIG. 5 is a schematic diagram of a comparison image corresponding to light pressing of a finger according to an embodiment of the disclosure. With reference to FIG. 4 and FIG. 5, in Step S220, the processor 110 may judge multiple analog-to-digital converter values of multiple pixels of the fingerprint image 300 according to a numerical mask to generate, for example, a comparison image 400 of FIG. 4 or a comparison image 500 of FIG. 5. In the embodiment, the numerical mask may be, for example, implemented in an algorithm and defined with a preset analog-to-digital converter numerical range. The processor 110 may retrieve a portion of the pixels of the fingerprint image 300 that is within the analog-to-digital converter numerical range based on the analog-to-digital converter numerical range to generate the comparison image 400 or the comparison image 500. In the embodiment, the pixels corresponding to the fingerprint image 300 generated by the optical fingerprint sensor 120 after sensing may, for example, respectively have analog-to-digital converter values ranging from 0 to 1000.

Taking the heavy pressing of the finger of FIG. 4 as an example, the processor 110 may define pixels at the same pixel position in the comparison image 400 to have a first value according to a portion of the pixels of the fingerprint image 300 with the analog-to-digital converter values greater than or equal to 300 and less than or equal to 600. For example, the pixels of a first numerical region 410 of FIG. 4 correspond to the value “1”. The processor 110 may define pixels at the same pixel position in the comparison image 400 to have a second value according to a portion of the pixels of the fingerprint image 300 with the analog-to-digital converter values less than 300 or greater than 600. For example, the pixels of a second numerical region 420 of FIG. 4 correspond to the value “0”. In this way, the processor 110 may generate the comparison image 400 as shown in FIG. 4.

Taking the light pressing of the finger of FIG. 5 as an example, the processor 110 may define the pixels at the same pixel position in the comparison image 500 to have the first value according to the portion of the pixels of the fingerprint image 300 with the analog-to-digital converter values greater than or equal to 300 and less than or equal to 600. For example, the pixels of a first numerical region 510 of FIG. 5 correspond to the value “1”. The processor 110 may define the pixels at the same pixel position in the comparison image 500 to have the second value according to the portion of the pixels of the fingerprint image 300 with the analog-to-digital converter values less than 300 or greater than 600. For example, the pixels of a second numerical region 520 of FIG. 5 correspond to the value “0”. In this way, the processor 110 may generate the comparison image 500 as shown in FIG. 5.

In Step S230, the processor 110 compares the comparison image 400 with a sample image 600 or compares the comparison image 500 with the sample image 600 to obtain the pressure level classification corresponding to the fingerprint image 300. The sample image 600 is a binary image having a first numerical distribution 610 and a second numerical distribution 620. In the embodiment, the sample image 600 may be, for example, the binary image generated via numerical retrieval processing and binarization processing after obtaining an image by the manufacturer of the electronic device 100 through a correction box or a pressure test object (to imitate finger pressing) before the product leaves the factory, so as to be used as a pressure classification reference map. Alternatively, in some other embodiments of the disclosure, the sample image 600 may also be the binary image generated by the numerical retrieval processing and the binarization processing from multiple comparison images generated by multiple fingerprint sensing under the condition of a known pressure level classification after the processor 110 respectively averages or superimposes the analog-to-digital converter values of the corresponding pixels of the comparison images. In addition, the processor 110 may synthesize and generate corresponding background data individually according to multiple fingerprint images having the same pressure level classification. The processor 110 may first respectively average the analog-to-digital converter values of the respective pixels of the fingerprint images, and then average multiple average analog-to-digital converter values of the fingerprint images to generate the background data with overall pixels having uniform analog-to-digital converter values. In other words, the background data is a uniform grayscale image with the same specific grayscale value.

Taking the heavy pressing of the finger as an example, referring to FIG. 4 and FIG. 6 at the same time, the processor 110 may calculate a first pixel number (for example, a value Type_A) of pixels having the second value in the sample image 600 (that is, corresponding to the second numerical distribution 620 of the sample image 600) and whose pixel positions overlap with pixels having the first value in the comparison image 400 (that is, corresponding to the first numerical region 410 of the comparison image 400). In addition, the processor 110 calculates a second pixel number (for example, a value Type_B) of pixels having the first value in the sample image 600 (that is, corresponding to the first numerical distribution 610 of the sample image 600) and whose pixel positions overlap with pixels having the second value in the comparison image 400 (that is, corresponding to the second numerical region 420 of the comparison image 400). Next, the processor 110 subtracts the first pixel number and the second pixel number to obtain a first computation value ((Type_A)−(Type_B)), and the processor 110 adds the first pixel number and the second pixel number to obtain a second computation value ((Type A)+(Type B)). The processor 110 divides the first computation value by the second computation value to obtain a pressure level score ((Type_A)−(Type_B)/(Type_A)+(Type_B)) of the pressure level classification.

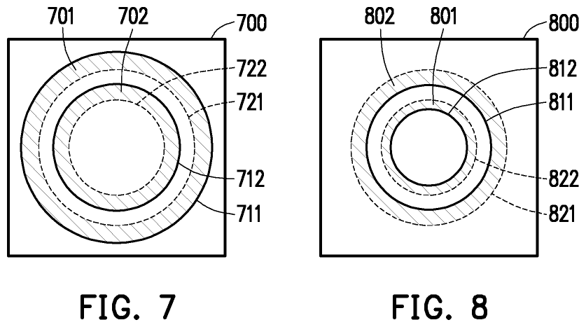

In this regard, referring to a range comparison result 700 of the comparison image and the sample image corresponding to the heavy pressing shown in FIG. 7, the comparison result shown in FIG. 7 may be applied to the comparison result of the comparison image 400 of FIG. 4 and the sample image 600 of FIG. 6. Since a contour formed by region boundaries 711 and 712 of the first numerical region corresponding to the comparison image (for example, the first numerical region 410 of the comparison image 400) is greater than a contour formed by region boundaries 721 and 722 of the first numerical distribution corresponding to the sample image (for example, the first numerical distribution 610 of the sample image 600), a pixel number of a region 701 corresponding to the value Type_A is greater than a pixel number of a region 702 corresponding to the value Type_B. In other words, the value Type_A is greater than the value Type_B. Therefore, the pressure level score is a positive number. In this regard, under the condition that the pressure applied by the user on the panel is average pressure application, the processor 110 may judge that the fingerprint image 300 of FIG. 3 is a fingerprint sensing result corresponding to a heavy pressing level. Therefore, the processor 110 may read a first background image corresponding to the heavy pressing level to perform the noise removal processing (to remove image noise generated due to screen deformation in the image) on the fingerprint image 300 of FIG. 3, so that the optimized fingerprint image may be effectively obtained.

Taking the light pressing of the finger as an example, referring to FIG. 5 and FIG. 6 at the same time, the processor 110 may calculate the first pixel number (for example, the value Type_A) of the pixels having the second value in the sample image 600 (that is, corresponding to the second numerical distribution 620 of the sample image 600) and whose pixel positions overlap with the pixels having the first value in the comparison image 500 (that is, corresponding to the first numerical region 510 of the comparison image 500). In addition, the processor 110 calculates the second pixel number (for example, the value Type_B) of the pixels having the first value in the sample image 600 (that is, corresponding to the first numerical distribution 610 of the sample image 600) and whose pixel positions overlap with the pixels having the second value in the comparison image 500 (that is, corresponding to the second numerical region 520 of the comparison image 500. Next, the processor 110 subtracts the first pixel number and the second pixel number to obtain the first computation value ((Type_A)−(Type_B)), and the processor 110 adds the first pixel number and the second pixel number to obtain the second computation value ((Type A)+(Type B)). The processor 110 divides the first computation value by the second computation value to obtain the pressure level score ((Type_A)−(Type_B)/(Type_A)+(Type_B)) of the pressure level classification.

In this regard, referring to a range comparison result 800 of the comparison image and the sample image corresponding to the light pressing shown in FIG. 8, the comparison result shown in FIG. 8 may be applied to the comparison result of the comparison image 500 of FIG. 5 and the sample image 600 of FIG. 6. Since a contour formed by region boundaries 811 and 812 of the first numerical region corresponding to the comparison image (for example, the first numerical region 510 of the comparison image 500) is less than a contour formed by region boundaries 821 and 822 of the first numerical distribution corresponding to the sample image (for example, the first numerical distribution 610 of the sample image 600), a pixel number of a region 801 corresponding to the value Type_A is less than a pixel number of a region 802 corresponding to the value Type_B. In other words, the value Type_A is less than the value Type_B. Therefore, the pressure level score is negative. In this regard, under the condition that the pressure applied by the user on the panel is average pressure application, the processor 110 may judge that the fingerprint image 300 of FIG. 3 is a fingerprint sensing result corresponding to a light pressing level. Therefore, the processor 110 may read a second background image corresponding to the light pressing level to perform the noise removal processing (to remove image noise generated due to screen deformation in the image) on the fingerprint image 300 of FIG. 3, so that the optimized fingerprint image may be effectively obtained.

However, in another embodiment, under the condition that the pressure applied by the user on the panel is non-average pressure application, the processor 110 may, for example, judge whether an absolute value of the pressure level score calculated in the embodiment of FIG. 7 or FIG. 8 is less than or equal to a preset threshold. When the absolute value of the pressure level score is close to the preset threshold, the processor 110 may judge that a pressing level corresponding to the fingerprint image 300 is close to a pressing level corresponding to the sample image 600. Therefore, the processor 110 may read a background image corresponding to the sample image 600 to perform noise removal processing. In other words, in another embodiment, the processor 110 may also respectively perform the computation of the pressure level score on the comparison image 400 and multiple different sample images, and judge which of the different sample images 600 is closest to the pressing level corresponding to the fingerprint image 300 through calculating the absolute value of the pressure level score, so that the most appropriate background image may be read to perform noise removal processing.

It is worth noting that the background images according to the foregoing embodiments may be, for example, multiple fingerprint images obtained by the manufacturer of the electronic device 100 before the product leaves the factory through multiple actual pressing with different weights of the finger. The processor 110 may perform the judgement operation of the pressure level on the fingerprint images, and then further process the fingerprint images to generate the background images corresponding to different pressure levels to be used for the noise removal processing. Alternatively, for the background image according to each of the foregoing embodiments, for example, after the electronic device 100 leaves the factory, the processor 110 may perform the judgement operation of the pressure level on multiple fingerprint images obtained by the user performing multiple fingerprint sensing, and then averaging grayscale values of the fingerprint images having the same pressure level classification to generate corresponding background data to be used for the noise removal processing.

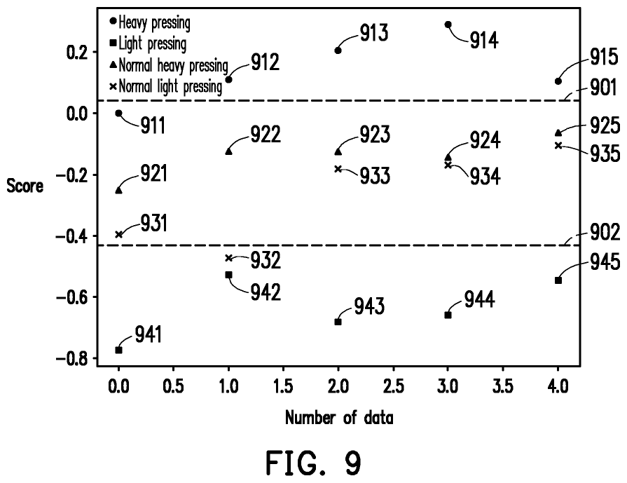

However, the pressure level classifications of the disclosure are not limited to the two classifications of the heavy pressing level and the light pressing level. Referring to FIG. 9, FIG. 9 is a schematic diagram of classification of multiple different pressure levels according to an embodiment of the disclosure. The electronic device 100 may be tested by the manufacturer before the product leaves the factory, or the electronic device 100 then passes several sensing results of the user to sort statistical results of multiple classification data with different pressure levels as shown in FIG. 9. In this regard, during one test sensing process, the processor 110 may sense plane weight blocks with various weights through the optical fingerprint sensor 120 to obtain four fingerprint images corresponding to different pressing pressure levels, and through the computation of the foregoing embodiment, the processor 110 may obtain four corresponding pressure level scores 911, 921, 931, and 941. Alternatively, the processor 110 may require the user to perform multiple heavy pressing and multiple light pressing to obtain four fingerprint images corresponding to different pressing pressure levels, and through the computation of the foregoing embodiment, the processor 110 may obtain the four corresponding pressure levels scores 911, 921, 931, and 941. By analogy, during two to four test sensing processes, the processor 110 may obtain four corresponding pressure level scores 922 to 925, 932 to 935, and 942 to 945. Then, the processor 110 may evaluate the four pressure level scores of each test sensing process to judge a corresponding heavy pressing level, normal heavy pressing level, normal light pressing level, and light pressing level. In this way, the processor 110 may classify at least two score thresholds 901 and 902 based on the pressure level scores 911 to 915, 921 to 925, 931 to 935, and 941 to 945. The score threshold 901 is, for example, the score 0.05, and the score threshold 902 is, for example, the score −0.55. Therefore, when the electronic device 100 is used for actual fingerprint sensing, the processor 110 may compare the pressure level score obtained by actual fingerprint sensing with the score thresholds 901 and 902.

In this way, if the pressure level score is significantly greater than the score threshold 901, the processor 110 judges that the corresponding pressure level is the heavy pressing level. If the pressure level score is close to (may be greater than or less than) the score threshold 901, the processor 110 judges that the corresponding pressure level is the normal heavy pressing level. If the pressure level score is close to (may be greater than or less than) the score threshold 902, the processor 110 judges that the corresponding pressure level is the normal light pressing level. If the pressure level score is significantly less than the score threshold 902, the processor 110 judges that the corresponding pressure level is the light pressing level. Accordingly, the processor 110 of the embodiment may perform effective noise removal processing (to remove image noise generated due to screen deformation in the image) on the fingerprint images obtained under different pressure level conditions, so as to obtain the optimized fingerprint image.

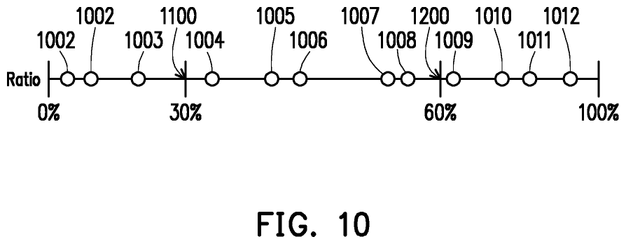

However, the manner of the processor 110 of the disclosure determining the pressure level classification is not limited to the above manner. For example, referring to FIG. 10, FIG. 10 is a schematic diagram of classification of multiple different pressure levels according to another embodiment of the disclosure. In the embodiment, the processor 110 may be pre-recorded with two sample images (similar to FIG. 6, but having the first numerical regions with different areas) corresponding to different pressure levels. The processor 110 may calculate a first reference pixel ratio 1100 of the pixels having the first value in a first sample image (that is, the ratio of the area occupied by the first numerical region to the overall image area in the first sample image), and the processor 110 may calculate a second reference pixel ratio 1200 of the pixels having the first value in a second sample image (that is, the ratio of the area occupied by the first numerical region to the overall image area in the second sample image). The first reference pixel ratio 1100 is, for example, 30%, and the second reference pixel ratio 1200 is, for example, 60%. Then, the processor 110 may calculate a first pixel ratio of the pixels having the first value in the comparison image, and the processor 110 may determine the pressure level classification according to a distribution relationship among the first pixel ratio, the first reference pixel ratio 1101, and the second reference pixel ratio 1200. In other words, the processor 110 may judge that the first pixel ratio is closest to one of the first reference pixel ratio 1101 and the second reference pixel ratio 1200 to determine the pressure level classification. For example, ratios 1001 to 1006 are closer to the first reference pixel ratio 1101, so the ratios 1001 to 1006 correspond to light pressing background data. Ratios 1007 to 1012 are closer to the second reference pixel ratio 1200, so the ratios 1007 to 1012 correspond to heavy pressing background data. Alternatively, the processor 110 may judge that the first pixel ratio is located in one of three ratio intervals between the first reference pixel ratio 1100 and the second reference pixel ratio 1200 to determine the pressure level classification. For example, the ratios 1001 to 1003 are located in a first interval, so the ratios 1001 to 1003 correspond to first background data. The ratios 1004 to 1008 are located in a second interval, so the ratios 1004 to 1008 correspond to second background data. The ratios 1009 to 1012 are located in a third interval, so the ratios 1009 to 1012 correspond to third background data.

In addition, in other embodiments of the disclosure, the processor 110 may also, for example, establish evaluation chart data having an X-axis (corresponding to a score calculation result) and a Y-axis (corresponding to a ratio calculation result) by integrating the evaluation manner of the foregoing embodiments to classify different pressure levels, so as to more detailly evaluate the pressure level classification result corresponding to the current fingerprint image.

In summary, in the electronic device and the fingerprint image correction method of the disclosure, the corresponding binary comparison image may be obtained through performing the numerical retrieval processing and the binarization processing on the fingerprint image, and through comparing the comparison image with the pre-stored sample image to effectively judge the pressure level of the finger of the user on the optical fingerprint sensor during the fingerprint sensing process. Therefore, the electronic device and the fingerprint image correction method of the disclosure may use the background data corresponding to the pressure level to correct the fingerprint image, and effectively generate the optimized fingerprint image for subsequent related fingerprint image applications.

Although the disclosure has been disclosed in the foregoing embodiments, the embodiments are not intended to limit the disclosure. Persons skilled in the art may make some changes and modifications without departing from the spirit and scope of the disclosure. The protection scope of the disclosure shall be defined by the appended claims.

What is claimed is:

1. An electronic device, comprising:
an optical fingerprint sensor, used to obtain a fingerprint image; and
a processor, coupled to the optical fingerprint sensor, wherein the processor judges a plurality of analog-to-digital converter values of a plurality of pixels of the fingerprint image according to a numerical mask to generate a comparison image, and
the processor compares the comparison image with a sample image to obtain a pressure level classification corresponding to the fingerprint image.

2. The electronic device according to claim 1, wherein the processor performs an image correction processing on the fingerprint image according to the corresponding pressure level classification to generate an optimized fingerprint image.

3. The electronic device according to claim 1, wherein the numerical mask is an analog-to-digital converter numerical range, and the analog-to-digital converter numerical range is between 300 and 600.

4. The electronic device according to claim 3, wherein the processor defines pixels at a same pixel position in the comparison image to have a first value according to a portion of the pixels of the fingerprint image with the analog-to-digital converter values greater than or equal to 300 and less than or equal to 600, and defines pixels at a same pixel position in the comparison image to have a second value according to a portion of the pixels of the fingerprint image with the analog-to-digital converter values less than 300 or greater than 600, wherein the sample image is a binary image having a first numerical distribution and a second numerical distribution.

5. The electronic device according to claim 4, wherein the processor calculates a first pixel number and a second pixel number, the first pixel number is a number of pixels having the first value in the comparison image and corresponding to pixel positions of pixels having the second value in the sample image, and the second pixel number is a number of pixels having the second value in the comparison image and corresponding to pixel positions of pixels having the first value in the sample image, wherein
the processor subtracts the first pixel number and the second pixel number to obtain a first computation value, and the processor adds the first pixel number and the second pixel number to obtain a second computation value, and
the processor divides the first computation value by the second computation value to obtain a pressure level score of the pressure level classification, and the processor reads background data according to a magnitude of the pressure level score.

6. The electronic device according to claim 5, wherein when the pressure level score is a positive number, the processor judges that the fingerprint image corresponds to a heavy pressing level compared to the sample image, and reads a first background image corresponding to the heavy pressing level to perform noise removal processing, and
when the pressure level score is a negative number, the processor judges that the fingerprint image corresponds to a light pressing level compared to the sample image, and reads a second background image corresponding to the light pressing level to perform the noise removal processing.

7. The electronic device according to claim 5, wherein when an absolute value of the pressure level score is close to a preset threshold, the processor judges that a pressing level corresponding to the fingerprint image is close to a pressing level corresponding to the sample image, and reads a third background image corresponding to the sample image to perform noise removal processing.

8. The electronic device according to claim 4, wherein the processor calculates a first reference pixel ratio of pixels having the first value in a first sample image, calculates a first pixel ratio of pixels having the first value in the comparison image, and determines the pressure level classification according to a difference between the first pixel ratio and the first reference pixel ratio.

9. The electronic device according to claim 8, wherein the processor calculates a second reference pixel ratio of pixels having the first value in a second sample image, and determines the pressure level classification according to a distribution relationship among the first pixel ratio, the first reference pixel ratio, and the second reference pixel ratio.

10. The electronic device according to claim 9, wherein the processor judges that the first pixel ratio is located in one of three ratio intervals between the first reference pixel ratio and the second reference pixel ratio to determine the pressure level classification.

11. The electronic device according to claim 1, wherein the processor averages grayscale values of a plurality of fingerprint images having a same pressure level classification to generate corresponding background data.

12. The electronic device according to claim 1, wherein the optical fingerprint sensor is a lenticular in-display fingerprint sensor.

13. A fingerprint image correction method, comprising:
obtaining a fingerprint image through an optical fingerprint sensor;
judging a plurality of analog-to-digital converter values of a plurality of pixels of the fingerprint image according to a numerical mask to generate a comparison image; and
comparing the comparison image with a sample image to obtain a pressure level classification corresponding to the fingerprint image.

14. The fingerprint image correction method according to claim 13, further comprising:
performing an image correction processing on the fingerprint image according to the corresponding pressure level classification to generate an optimized fingerprint image.

15. The fingerprint image correction method according to claim 13, wherein the numerical mask is an analog-to-digital converter numerical range, and the analog-to-digital converter numerical range is between 300 and 600.

16. The fingerprint image correction method according to claim 15, wherein the step of generating the comparison image comprises:
defining pixels at a same pixel position in the comparison image to have a first value according to a portion of the pixels of the fingerprint image with the analog-to-digital converter values greater than or equal to 300 and less than or equal to 600; and
defining pixels at a same pixel position in the comparison image to have a second value according to a portion of the pixels of the fingerprint image with the analog-to-digital converter values less than 300 or greater than 600, wherein
the sample image is a binary image having a first numerical distribution and a second numerical distribution.

17. The fingerprint image correction method according to claim 16, wherein the step of obtaining the pressure level classification corresponding to the comparison image comprises:
calculating a first pixel number of pixels having the second value in the sample image and whose pixel positions overlap with pixels having the first value in the comparison image;
calculating a second pixel number of pixels having the first value in the sample image and whose pixel positions overlap with pixels having the second value in the comparison image;
subtracting the first pixel number and the second pixel number to obtain a first computation value;
adding the first pixel number and the second pixel number to obtain a second computation value;
dividing the first computation value by the second computation value to obtain a pressure level score of the pressure level classification; and
reading background data according to a magnitude of the pressure level score.

18. The fingerprint image correction method according to claim 17, wherein the step of reading the background data comprises:
judging that the fingerprint image corresponds to a heavy pressing level compared to the sample image when the pressure level score is a positive number, and reading a first background image corresponding to the heavy pressing level to perform noise removal processing; and
judging that the fingerprint image corresponds to a light pressing level compared to the sample image when the pressure level score is a negative number, and reading a second background image corresponding to the light pressing level to perform the noise removal processing.

19. The fingerprint image correction method according to claim 17, wherein the step of reading the background data comprises:
judging that a pressing level corresponding to the fingerprint image is close to a pressing level corresponding to the sample image when an absolute value of the pressure level score is close to a preset threshold, and reading a third background image corresponding to the sample image to perform noise removal processing.

20. The fingerprint image correction method according to claim 16, wherein the step of obtaining the pressure level classification corresponding to the comparison image comprises:
calculating a first reference pixel ratio of pixels having the first value in a first sample image;
calculating a second reference pixel ratio of pixels having the first value in a second sample image, wherein the processor calculates a first pixel ratio of pixels having the first value in the comparison image; and
determining the pressure level classification according to a distribution relationship among the first pixel ratio, the first reference pixel ratio, and the second reference pixel ratio.

21. The fingerprint image correction method according to claim 20, wherein the step of determining the pressure level classification comprises:
judging that the first pixel ratio is closest to one of the first reference pixel ratio and the second reference pixel ratio to determine the pressure level classification.

22. The fingerprint image correction method according to claim 21, wherein the step of determining the pressure level classification comprises:
judging that the first pixel ratio is located in one of three ratio intervals between the first reference pixel ratio and the second reference pixel ratio to determine the pressure level classification.

23. The fingerprint image correction method according to claim 19, further comprising:
averaging grayscale values of a plurality of fingerprint images according to the fingerprint images having a same pressure level classification to generate the corresponding background data.

24. The fingerprint image correction method according to claim 13, wherein the optical fingerprint sensor is a lenticular in-display fingerprint sensor.
